(19) United States
(12) Patent Application Publication
(10) Pub. No.: US 2023/0384417 A1
(43) Pub. Date: Nov. 30, 2023

(54) HYBRID RADAR AND COMMUNICATION APPARATUS

(71) Applicant: BAE SYSTEMS Information and Electronic Systems Integration Inc., Nashua, NH (US)

(72) Inventors: David A. Mouille, Bethlehem, PA (US); David A Haessig, JR., Towaco, NJ (US)

(73) Assignee: BAE SYSTEMS Information and Electronic Systems Integration Inc., Nashua, NH (US)

(21) Appl. No.: 17/752,925

(22) Filed: May 25, 2022

(51) Int. Cl. G01S 7/36; H04B 1/00; H04W 12/037

(52) U.S. Cl. CPC G01S 7/36; H04B 1/0053; H04W 12/037

(57) ABSTRACT

A hybrid RADAR and communication system provides both RADAR and wireless communication (COMMS) that share the same antenna, transmit and receive amplifiers, and other hardware, thereby reducing size, weight, and power requirements. In embodiments, COMMS implementation only requires adding additional software to a RADAR system. Embodiments are EW/COMMS systems that provide electronic warfare and wireless communication. EW/COMMS embodiments facilitate communication in hostile environments by enabling data exchange at any frequency within a broad EW frequency range. Communication signals can be obfuscated by interleaving them with EW waveforms at the same RF frequency. Collaborative communication between EW systems is enhanced by reducing EW communication lag times. Systems with physically distinct broadband and narrow band receivers can negotiate data exchange timing and frequencies by exchanging low power, low data rate control signals that are detected by the broadband receiver, while subsequent high density data bursts are received by the narrowband receiver.

### FIELD OF THE INVENTION

The invention relates to wireless communication, and more particularly, to vehicles that require both radar and wireless communication.

### BACKGROUND OF THE INVENTION

Many different types of personal and commercial vehicles are equipped with wireless communication (COMMS) and/or RADAR capabilities. For example, many private and commercial automobiles and trucks, including self-driving vehicles, use RADAR to detect nearby hazards, such as other vehicles and pedestrians. Similarly, private and commercial aircraft, including non-piloted drones, are typically equipped with RADAR for detecting weather and other aircraft, and in some cases for other purposes such as mapping ground features. Of course, piloted aircraft and drones typically also require wireless communication systems, so that pilots can report their status and receive instructions from control towers, and so that drones can report their positions and receive controlling signals,

In addition, many military ground vehicles, and nearly all military aircraft, are equipped with both RADAR and COMMS. Often, the success of combat operations requires a COMMS system on a military vehicle to provide secure and reliable communication between friendly forces. Accordingly, many military vehicles are equipped with secure, robust communication apparatus, such as LINK-16 apparatus. Typically, specific frequency bands are assigned for such communication, with each apparatus selecting an appropriate combination of RF channels within the designated bands.

Electronic warfare (EW) has also become a nearly essential aspect of modern warfare. As a result, EW apparatus is implemented on many types of military aircraft, both manned and unmanned, as well as military ground vehicles and naval ships. EW can include both detecting and disrupting hostile radar, hostile communications, and other hostile wireless transmissions. Disrupting hostile radar in particular can be mission critical, and can require immediate, effective, and persistent implementation so as to prevent hostile missiles and other hostile weapons from “locking” onto and threatening friendly assets.

For some civilian and commercial applications, such as small, light, remotely controlled drones, the requirement to include both wireless communication and RADAR capabilities can place a significant weight, cost, and energy burden onto the system. Also, in military applications such as combat drones, the requirement for both secure wireless communications and EW capability can limit the volume, weight and power that is available for other types of apparatus, such as cameras, weapons, and such like. Furthermore, frequency band limitations that are applicable to secure communications, such as Link-16, can render them vulnerable to hostile jamming, such that hostile EW creates a “communication denied” environment.

Furthermore, even though military communications typically employ sophisticated encryption, in many cases hostile forces are nevertheless able to glean valuable information from intercepted friendly communications, for example by triangulating the source locations of the transmissions. Accordingly, it is sometimes desirable to render wireless communications in combat environments as difficult as possible to intercept.

When a plurality of aircraft or other military assets are operating as a group within an area, it can often be desirable for them to share information, for example to enable triangulation of the location of hostile radar by comparing detections made at different locations by the EW systems of the various assets. However, because this information must be routed from the EW systems through the communication systems, there is an inevitable time lag before information detected by one of the EWs can reach the other EWs in the group. This inter-EW communication time lag can degrade the accuracy of the triangulations and other derived information.

What is needed, therefore, is an apparatus that can provide both RADAR and wireless communication for a vehicle, while reducing the size, weight, and power requirements of the apparatus.

### SUMMARY OF THE INVENTION

The present disclosure is an apparatus that can provide both RADAR and wireless communication for a vehicle, while reducing the size, weight, and power requirements of the apparatus. Some embodiments are applicable to civilian and commercial vehicles, such as driverless automobiles and trucks, that rely on RADAR to avoid obstacles, and that could benefit from establishing a wireless network with other, proximate, similarly equipped vehicles so as to coordinate their navigation. Such an enhancement could become of increasing value as driverless cars and trucks becomes more numerous. The present disclosure can provide a means to establish such inter-vehicle COMMS without addition of significant hardware or cost. Similar embodiments apply to civilian and commercial aircraft, including unpiloted drones.

In other embodiments, a hybrid EW warfare and COMMS apparatus is disclosed that enables reliable wireless communication in communication denied environments, and in some embodiments also renders friendly communications more difficult to intercept, reduces the size, weight, and power requirements of communication and EW apparatus, and/or reduces the time lag associated with inter-EW communications.

Much of the disclosure herein is directed to a hybrid EW/COMM apparatus that is suitable for military applications. However, it should be understood that embodiments of the present disclosure also extend to commercial and consumer applications, such as ground vehicles and civilian aircraft that require both RADAR and COMMS, and can benefit from the reduced weight, space, and cost that is provided by the disclosed apparatus.

It is notable that EW systems are generally required to operate over a wide range of RF frequencies, such as from 400 MHz to 40 GHz, which is typically much wider than the frequency range assigned to secure communications such as Link 16. Also, it is notable that most EW systems are required to both receive and transmit RF over this wide range of frequencies. Accordingly, most EW systems include one or more antennae, an RF transmitting amplifier, and an RF receiving amplifier, all of which are able to function over the full EW frequency range. In addition, EW systems include A/D and D/A converters, and frequency upconverters and downconverters that are able to convert any received waveforms from within this broad EW frequency range into a received EW waveform at an EW “intermediate frequency” (EWI frequency), and are also able to convert an EW waveform generated by an EW control module from the EW frequency to any desired transmission frequency within the broad EW frequency range.

Typically, the output of the RF receiving amplifier of an EW system will be directed to two distinct receivers, one of which is a narrow band or “NB” receiver that includes a digital bandpass filter, and is configured for high sensitivity detection of signals within a selectable, limited bandwidth, while the other receiver is a broadband or “BB” receiver that is able to simultaneously monitor the full EW frequency range. The implementation of two distinct receivers allows the BB receiver to continuously monitor the entire EW frequency range, and to rapidly detect any hostile transmissions that might appear anywhere within the EW frequency range, while allowing the NB receiver to simultaneously focus on a specific frequency band where hostile transmissions have been, or are likely to be, detected. All of the elements of the EW system are typically controlled by software operating on the EW control module, which also provides digital filtering, recognition of threats, selection of countermeasures, and all other control requirements of the EW system.

According to embodiments of the present disclosure, an EW system is enhanced and adapted to function as a combined EW and communication (EW/COMM) system. In some embodiments, additional hardware is included, such as a physically distinct COMMS control module, and/or one or more additional antennae to provide required directional or omni-directional transmission and reception of communication signals. In other embodiments, the adaptation of the EW system for wireless communication is implemented mainly or entirely in software, enabling the existing EW hardware to maintain its original functionality while also serving as a communications system. In these embodiments, software is added to the EW controller that can direct the hardware to establish communication links and exchange message data. In embodiments, the added software can also encrypt and decrypt messages. Accordingly, the EW system is enhanced at least by adding a COMMS controller, which in some embodiments is implemented on a separate computing device, while in other embodiments the COMMS controller is implemented logically by adding software to the computing device that hosts the EW controller.

Embodiments of the present disclosure provide a hybrid EW and communication (EW/COMM) system that enables the transmission and reception of communication signals at any EW RF frequency, i.e. over a much wider range of frequencies than are typically available to conventional warfare communication systems such as Link 16. As a result, communication can be enabled in an otherwise communication-denied environment.

According to various embodiments of the present disclosure, data communication between two or more of the EW/COMM systems is initiated by an exchange of “control” signals that are communicated in the “background,” i.e. without disturbing the EW functionality of the system, via low power, low data rate control signals that are transmitted by the EW systems via one or more control channels assigned to pre-established frequencies, which can be fixed or varied in a predetermined manner. The control signals are detected by the BB receivers of the EW/COMM systems, which also continue to perform their EW frequency monitoring, while the NB receivers remain free to continue their EW functions.

In embodiments, the control signals are received at power levels that are below the ambient noise threshold, making them very difficult to detect unless their transmission parameters (spreading pattern, frequency hopping pattern, symbol rate, clock jitter pattern, etc.) are known a-priori. By monitoring the known control channel frequencies, and by accumulating received signals over relatively long intervals, according to the low control signal data rates and according to the known patterns of the control signals, the EW/COMM is able to reliably detect the control signals even when they are well below the noise threshold.

In various embodiments, the control signals are rendered more difficult to detect by taking advantage of the wide instantaneous bandwidth of the EW system and spreading the bandwidth of the control signals using direct sequence spreading at a high spreading rate. For example, if the spreading code length is 1000, then the spreading gain can be 10 log₁₀(1000)=30 dB. Thus, if the broadband receiver needs +10 dB to receive the control signals after de-spreading, the spread control signals can arrive at the receiver at a −20 dB signal to noise ratio over the air, i.e. well below the noise level, and therefore very difficult to detect.

In embodiments, the control signals are used by the EW/COMM systems to alert each other when data communication is desired, and to determine a frequency (or frequency pattern) and timing of the desired data exchange that will not interfere with any ongoing EW activities. Data is then exchanged between the EW/COMM systems using their NB receivers according to the determined frequency and timing. In embodiments, the data is transmitted in high data rate communication “bursts.”

It will be understood that the term “low data rate,” as used in the present disclosure, refers to data rates that are typically below 100 kbits/second, and that the term “high data rate” as used in the present disclosure refers to data rates that are typically above 10 MBits per second.

Because, in embodiments, the disclosed EW/COMM hybrid systems provide direct communication between the EW systems themselves, the “lag” that is associated with inter-EW communication is greatly reduced, as compared to traditional communication via e.g. Link 16, so that the triangulations and other collaborative intelligence that results from inter-EW communications is greatly improved.

“Sharing” of the NB receiver between its EW and data communication functions is accomplished in various embodiments by frequency and/or time-dependent multiplexing. For example, a communication frequency can be selected that is separated from an active EW frequency, but is nevertheless within the same frequency band or “channel” as the EW frequency. The NB receiver is thereby able to remain tuned to the desired EW frequency band, while appropriate digital filters enable simultaneous detection of EW signals and COMM signals. And by digitally “mixing” EW and COMM transmissions, the EW/COMM is also able to transmit on both frequencies simultaneously. In some embodiments, this approach can tend to obfuscate the data communications, in that they will be difficult to distinguish from the EW transmissions.

Other embodiments take advantage of gaps between the time windows in which the EW signals are received to shift the NB receiver from the EW frequency to the negotiated COMM frequency and back again, thereby time-interleaving the two functions of the NB receiver. This approach allows the COMM frequency to be selected anywhere within the EW frequency range. In some of these embodiments, the communication signals are interleaved in time with the EW signals, such that they are transmitted alternately, i.e. at different times, but at the same frequency. With appropriate encryption of the communications, they can become almost indistinguishable from EW signals, such that the communication signals are obfuscated, thereby rendering hostile detection and interception of the communications highly difficult.

It is notable that modern radar systems typically operate in a pulsed mode, whereby the radar emits RF as a discrete series of pulses, with the echoed RF energy being detected in between the pulses. EW disruption of such pulsed hostile radar typically includes detecting by the NB receiver of the radar pulses, and transmitting responding RF bursts that are intended to confuse the radar as to the range, speed, and other aspects of the asset that is employing the EW. Once the timing of the hostile radar pulses is established, the NB receiver is free during the time between the incoming radar pulses to be redirected to other frequencies for communication purposes.

Similarly, disruption of hostile communications (i.e. jamming) does not necessarily depend upon continuous jamming. Instead, gaps can often be included in the jamming signal without significantly degrading the jamming effect, so long as the timing of the gaps is not easily discerned by hostile forces. Embodiments take advantage of these jamming gaps for time-multiplexing of the NB receiver.

In embodiments, the communication signals are complex (real and imaginary) “IQ” signals, i.e. digital signals that are encoded in both amplitude and phase. In some embodiments, the communication signals are transmitted using the “digital data link” (DDL) protocol.

One general aspect of the present disclosure is a hybrid system that is a hybrid RADAR and signal communication system. The hybrid system includes an antenna, an RF receiving system comprising a broadband receiver and a narrowband receiver, the broadband and narrowband receivers being configured to enable the broadband receiver to continuously monitor a broad frequency range while concurrently the narrowband receiver detects signals that are received within a narrow frequency band included within the broad frequency range, an RF transmitting system, a RADAR control module configured to control the generation and receiving of RADAR energy by the antenna, RF receiving system, and RF transmitting system, and a communications module (COMMS) configured to control transmitting and receiving of communication signals by the antenna, RF transmitting system, and RF receiving system.

In embodiments, the COMMS is not physically distinct from the RADAR control module, but instead is a module of software code that is included in non-transient media within the RADAR control module.

Any of the above embodiments can be configured such that:
the RADAR system is an electronic warfare (EW) system;
the RADAR module is an EW control module;
the hybrid system is an EW/COMM system;
the broadband frequency range is an EW frequency range;
the receiving system is configured to receive a hostile waveform at any frequency within the EW frequency range;
the EW control module is configured to generate an EW waveform in response to the received hostile waveform;
the RF transmitting system is configured to transmit the EW waveform at any frequency within the EW frequency range;
the communication signals can be transmitted and received at any selected frequency within the EW frequency range; and
the broadband and narrowband receivers are configured to enable the broadband receiver to continuously monitor the full EW frequency range while, concurrently, the narrowband receiver detects hostile electronic warfare signals that are received within the narrow frequency band.

In some of these embodiments, the EW frequency range extends at least from 400 MHz to 36 GHz.

In any of the above embodiments, the broadband receiver can be further configured to receive control signals transmitted over a predetermined pattern of frequencies within the EW frequency range.

In any of the above embodiments, the narrowband receiver can be further configured to receive data communications.

Any of the above embodiments can further include a scrambler and a descrambler configured for encrypting and decrypting the communication signals.

In any of the above embodiments, the hybrid system can include a plurality of antennae. In some of these embodiments, at least one of the antennae is dedicated to only transmitting and/or receiving communication signals. In any of these embodiments, at least one of the antennae can be dedicated to only transmitting and/or receiving radar signals.

In any of the above embodiments, the COMMS can be configured to generate and to receive communication signals according to the digital data link (DDL) protocol.

In any of the above embodiments, the COMMS can be configured to generate and to receive IQ encoded communication signals.

A second general aspect of the present disclosure is on-transient media containing software, the non-transient media being included in a hybrid electronic warfare and signal communication system (EW/COMM) that includes an antenna, a receiving RF amplifier that is configured to receive a hostile waveform at any frequency within the EW frequency range, an RF receiving system, an EW control module configured to generate an EW waveform in response to the received hostile waveform, a transmitting RF amplifier that is configured to transmit the EW waveform at any frequency within an EW frequency range of the EW/COMM, and a communications module (COMMS) configured to generate and receive communication signals, the communication signals being transmittable and receivable via the antenna, the receiving system, and the transmitting and receiving RF amplifiers, at any selected frequency within an EW frequency range of the EW/COMM.

The software, when executed by the EW/COMM system, is configured to cause the EW/COMM system to communicate data while also concurrently engaging in electronic warfare by executing the steps of causing the EW control module to receive a hostile RF signal at an EW frequency via the antenna, the receiving RF amplifier, and the RF receiving system, causing the EW control module to transmit an EW waveform at the EW frequency via the transmitting RF amplifier and antenna, causing the COMMS to obtain received data at a communication receiving frequency via the receiving RF amplifier and RF receiving system, and causing the COMMS to emit transmitted data at a communication transmitting frequency via the transmitting RF amplifier.

In embodiments, the communication transmitting and receiving frequencies are both substantially equal to the EW frequency. In some of these embodiments, the receiving and transmitting by the COMMS occurs during gap times when the EW control module is neither receiving the hostile RF signals nor transmitting the EW waveforms.

In any of the above embodiments, the EW/COMM can further include a broadband receiver and a narrowband receiver, the narrowband receiver being physically distinct from the broadband receiver, and the software can be further configured to cause the EW/COMM system to execute the steps of causing the broadband receiver to continuously monitor the EW frequency range for hostile RF energy, causing the COMMS to transmit first control signals over a first control channel implemented according to a predetermined first frequency pattern, causing the COMMS to receive second control signals via the broadband receiver over a second control channel implemented according to a predetermined second frequency pattern, causing the COMMS to transmit the transmitted data at a first data communication frequency, and causing the COMMS to receive the received data at a second data communication frequency via the narrowband receiver, the first and second communication frequencies being determined according to the first and second control signals.

In some of these embodiments, the EW frequency and the second data communication frequency are both within a bandwidth of the narrowband receiver. In some of these embodiments, the hostile RF signals and the received data are concurrently received by the narrowband receiver. And in any of these embodiments, the EW frequency can be substantially equal to the second data communication frequency, and wherein the received data is received during gap times when the narrowband receiver is not receiving the hostile RF signals.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A is a block diagram that illustrates the components of a typical EW system of the prior art;

FIG. 1B is a block diagram that illustrates components of the disclosed EW/COMM in an embodiment of the present disclosure;

FIG. 1C illustrates time dependent multiplexing of the narrowband receiver between its EW and communication functions;

FIG. 2 illustrates transmission of radar jamming signals at first and second RF frequencies by EW/COMM units of two aircraft, interleaved with an exchange of communication signals between the two aircraft at a third RF frequency via the EW/COMM units in an embodiment of the present disclosure;

FIG. 3 illustrates the time interleaved transmission of EW waveforms and communication signals at the same RF frequency by the EW/COMM of an aircraft in an embodiment of the present disclosure; and

FIG. 4 is a flow diagram that illustrates a method of the present invention.

### DETAILED DESCRIPTION

The present disclosure is an apparatus that can provide both RADAR and wireless communication to a vehicle while reducing the size, weight, and power requirements of the apparatus. In embodiments, a hybrid EW warfare and COMMS apparatus is disclosed that enables reliable wireless communication in communication denied environments, and in embodiments also renders friendly communications more difficult to intercept, and/or reduces the time lag associated with inter-EW communications.

Much of the disclosure herein is directed to a hybrid EW/COMM apparatus that is suitable for military applications. However, it should be understood that embodiments of the present disclosure also extend to commercial and consumer applications, such as ground vehicles and civilian aircraft that require both RADAR and COMMS, and can benefit from the reduced weight, space, and cost that is provided by the disclosed apparatus. Examples include self-driving cars and trucks, as well as civilian drones.

It is notable that EW systems are generally required to operate over a wide range of RF frequencies, such as from 400 MHz to 40 GHz, which is typically much wider than the frequency range assigned to secure communications such as Link 16. Also, it is notable that most EW systems are required to both receive and transmit RF over this wide range of frequencies.

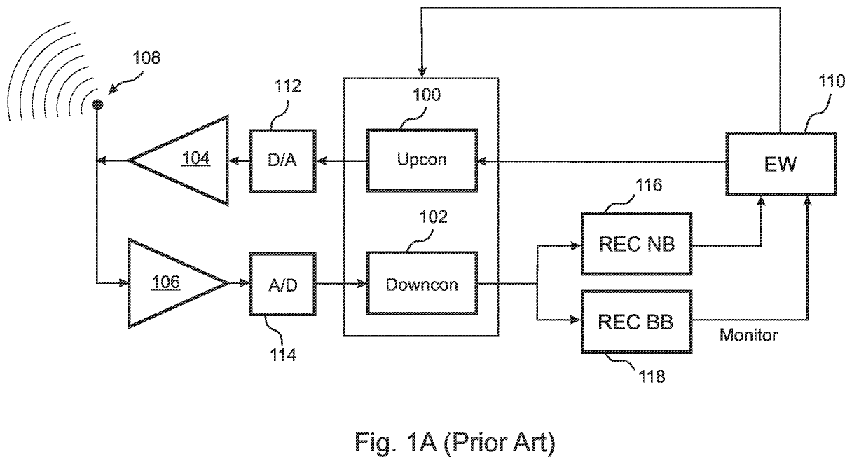

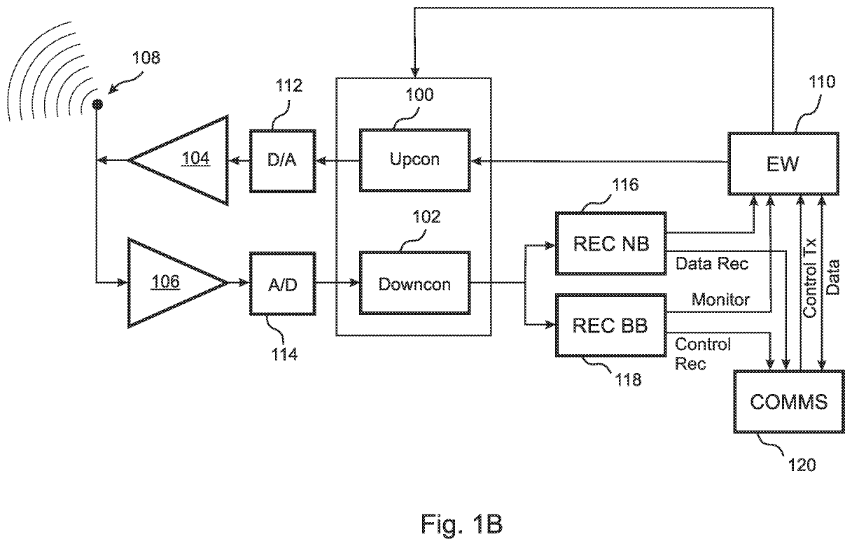

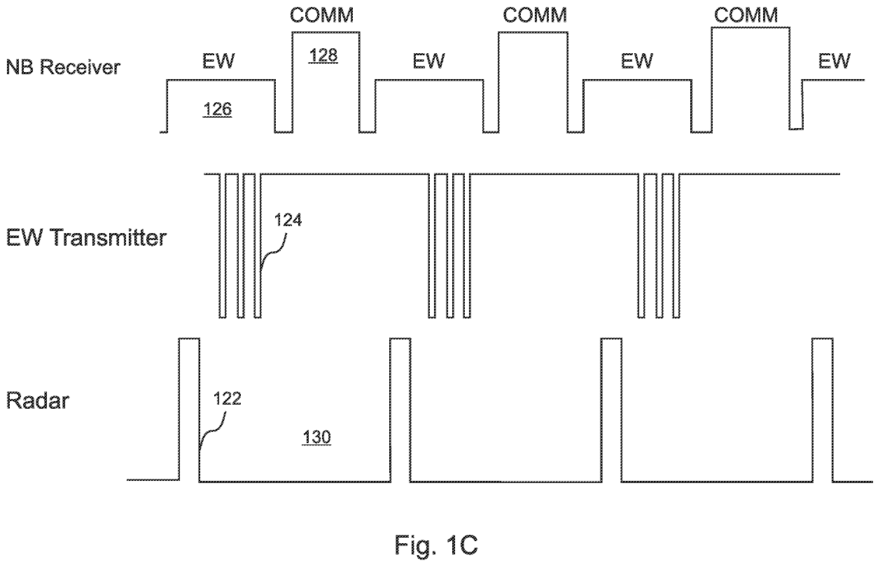

With reference to FIG. 1A, most EW systems include one or more antennae 108, an RF transmitting amplifier 104, and an RF receiving amplifier 106, all of which are able to function over the full EW frequency range. In addition, EW systems include A/D 114 and D/A 112 converters, as well as frequency upconverters 100 and downconverters 102 that are able to convert any received waveforms from within this broad EW frequency range into a received EW waveform at an EW “intermediate frequency” (EWI frequency), and are also able to convert an EW waveform generated by an EW control module 110 from the EWI frequency to any desired transmission frequency within the broad EW frequency range.

Typically, the output of the RF receiving amplifier 106 in an EW system will be directed via the A/D converter 114 and the downconverter 102 to two distinct receivers, one of which is a narrow band or “NB” receiver 116 that includes a digital bandpass filter, and is configured for high sensitivity detection of signals within a selectable, limited bandwidth, while the other receiver is a broadband or “BB” receiver 118 that is able to concurrently monitor the full EW frequency range. The outputs of both receivers 116, 118 are directed to the EW control module 110, which analyzes any detected hostile RF and directs appropriate countermeasure EW signals to the output amplifier 104 via the upconverter 100 and D/A converter 112.

The implementation of two physically distinct receivers 116, 118 in EW systems, as illustrated in FIG. 1A, allows the BB receiver 118 to continuously monitor the entire EW frequency range, and to rapidly detect any new hostile transmissions that might appear anywhere within the EW frequency range, while allowing the NB receiver 116 to concurrently focus on a specific frequency band where hostile transmissions have been, or are likely to be, detected.

Embodiments of the present disclosure provide a hybrid EW and communication (EW/COMM) system that performs the EW functions of a conventional EW system, while also making use of the EW hardware to transmit and receive communication signals at any EW RF frequency, i.e. over a much wider range of frequencies than are typically available to conventional warfare communication systems such as Link 16. As a result, communication is enabled in an otherwise communication-denied environment.

With reference to FIG. 1B, a hybrid EW and communication (EW/COMM) system in an embodiment of the present disclosure includes a communications module (COMMS module) 120 that functions as a signal generator and receiver configured to generate and receive communication signals at a COMM intermediate frequency (CI frequency). In various embodiments, the CI frequency can be equal to the EWI frequency, or it can be different from the EWI frequency. In embodiments, the COMMS module 120 is also able to encrypt and decrypt messages.

According to various embodiments of the present disclosure, a data communication between two or more of the EW/COMM systems is initiated by an exchange of “control” signals that are communicated in the “background,” i.e. without disturbing the EW functionality of the system, via low power, low data rate control signals that are transmitted by the EW systems via one or more control channels assigned to pre-established frequencies, which can be fixed or varied in a predetermined manner. The control signals are detected by the BB receivers 118 of the EW/COMM systems, which also continue to perform their broadband EW frequency monitoring, while the NB receivers 116 continue their EW functions uninterrupted.

If communication is to be established between two EW/COMM systems, in some embodiments a pair of control channels are used, where each of the EW/COMM systems uses one of the two control channels for transmitting control signals, while monitoring the other of the two control channels to receive control signals from the other EW/COMM system. If a data network is to be formed between more than two EW/COMM systems, then additional control channels can be used, and/or other methods can be employed that are known in the art for avoiding and/or dealing with data collisions.

For example, a first EW/COMM system can transmit a low data rate control signal over a first control channel requesting to initiate data communication with a second EW/COMM system, and indicating timing and frequencies options for the data communication that will not interfere any current EW activities of the first EW/COMM system. The second EW/COMM system receives this transmission over the first data channel using its BB receiver 118. It can then respond on a second low data rate control channel confirming timing and frequencies for data communication that are selected from among the options suggested by the first EW/COMM system, and that will also avoid interference with any ongoing EW activity of the second EW/COMM system. The response is received by the first EW/COMM system via its BB receiver 118.

Once the timing and frequencies for the data communication have been established via this exchange of control signals, the two EW/COMM systems can implement the data communication according to the determined timing and frequencies using their separate NB receivers 116 to enable the reception of high data rate communications, e.g. via high data rate “bursts” of information.

It should be noted that in FIG. 1B the “COMMS” module 120 is illustrated as a physically separate module that is distinct from the EW control module 110. However, in some embodiments the COMMS functionality 120 is implemented by adding additional instruction coding to the EW control module 110, with few if any hardware changes or additions being required, and without need for a physically distinct COMMS module 120. Examples of instructions that can be added to the EW control module 110 include instructions that cause the RF transmitting amplifier 104 and broadband receiver 118, among other components of the system, to exchange control signals with other EW systems, as well as instructions that cause the RF transmitting amplifier 104, RF receiving amplifier 106, and narrowband receiver 116 to exchange high speed data bursts with other EW systems. Instructions can also be included that enable encrypting and decrypting of communicated data.

Because the disclosed EW/COMM hybrid systems provide direct communication between the EW systems themselves, the “lag” that is associated with inter-EW communication is greatly reduced, as compared to traditional communication via e.g. Link 16, so that the triangulations and other collaborative intelligence that results from inter-EW communications is greatly improved.

“Sharing” of the NB receiver 116 between its EW and data communication functions is accomplished, in various embodiments, by frequency and/or time-dependent multiplexing. For example, a communication frequency can be selected that is separated from an active EW frequency, but is nevertheless within the same frequency band or “channel” as the EW frequency. The NB receiver 116 is thereby able to remain tuned to the desired EW frequency band, while appropriate digital filters enable simultaneous detection of EW signals and COMM signals. And by digitally “mixing” EW and COMMS transmissions, the EW/COMM is also able to transmit on both frequencies simultaneously. In some embodiments, this approach can tend to obfuscate the data communications, in that they will be difficult to distinguish from the EW transmissions.

Other embodiments take advantage of gaps between the time windows in which the EW signals are received to shift the NB receiver 116 from the EW frequency to the negotiated COMMS frequency and back again, thereby time-interleaving the two functions of the NB receiver 116. This approach allows the COMMS frequency to be selected anywhere within the EW frequency range. In some of these embodiments, the COMMS frequency is the same as the EW frequency, with the EW and communication signals being transmitted alternately, i.e. at different times, but at the same frequency. With appropriate encryption of the communications, the communication signals can be almost indistinguishable from the EW signals, such that the communication signals are obfuscated, thereby rendering hostile detection and interception of the communications highly difficult.

With reference to FIG. 1C, it is notable that modern radar systems typically operate in a pulsed mode, whereby the radar emits RF as a discrete series of pulses 122, with the echoed RF energy being detected in between the pulses 122. EW disruption of such pulsed hostile radar typically includes detecting by the NB receiver 116 of the radar pulses 122, and transmitting responding RF bursts 124 that are intended to confuse the radar as to the range, speed, and/or other aspects of the asset that is employing the EW. Once the timing of the hostile radar pulses 122 is established, the NB can be switched between an EW frequency 126 and the communication frequency 128, such that the NB receiver 116 is tuned to the EW frequency 126 during the radar pulses 122, and is re-tuned to the COMM frequency 128 during the gaps 130 between the radar pulses 122. In the illustrated example, the NB receiver 116 remains at the EW frequency 126 during the EW pulse burst 124, so that the upconverter 100 continues to upconvert from the EWI frequency to the EW frequency during the EW bursts 124.

Similarly, disruption of hostile communications (i.e. jamming) does not necessarily depend upon continuous jamming. Instead, gaps can often be included in the jamming signal without significantly degrading the jamming effect, so long as the timing of the gaps is not easily discerned by hostile forces. Embodiments take advantage of these jamming gaps for time-multiplexing of the NB receiver 116.

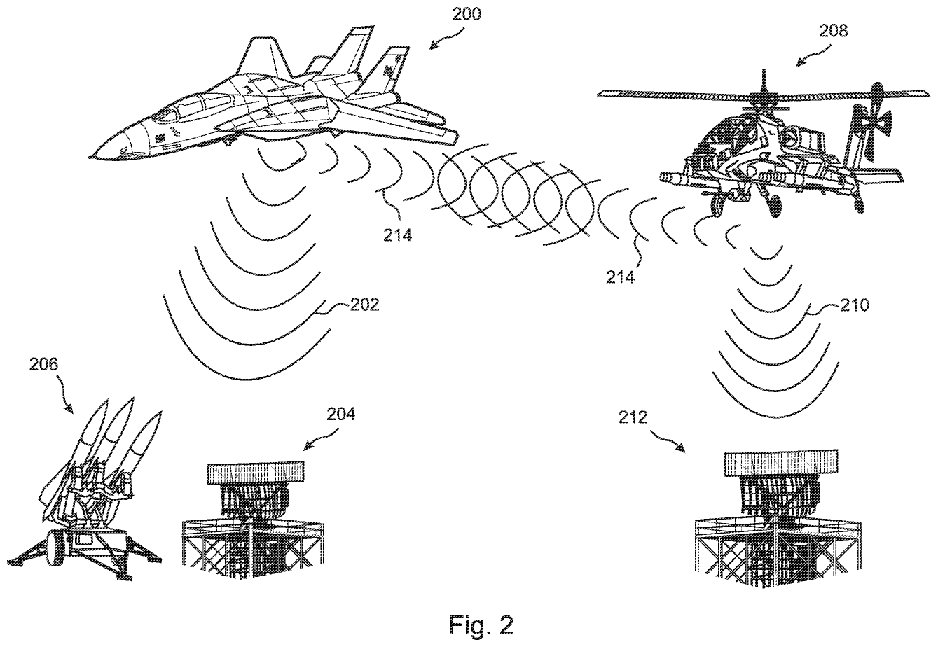

In the example of FIG. 2, the EW/COMM system of a first aircraft 200 is transmitting an EW signal 202 at a first EW frequency which is jamming a first radar 204 that controls the launching of anti-aircraft missiles 206. At the same time, the EW/COMM system of a second aircraft 208 is transmitting an EW signal 210 at a second EW frequency that is jamming a second radar 212. Concurrently, the EW/COMM systems of the two aircraft 200, 208 communicate with each other at a third COMM frequency 214. In the example of FIG. 2, the frequencies of the communication signals 214 are distinct from the EW frequencies 202, 210, such that they can occur simultaneously and can be distinguished from each other by frequency duplexing.

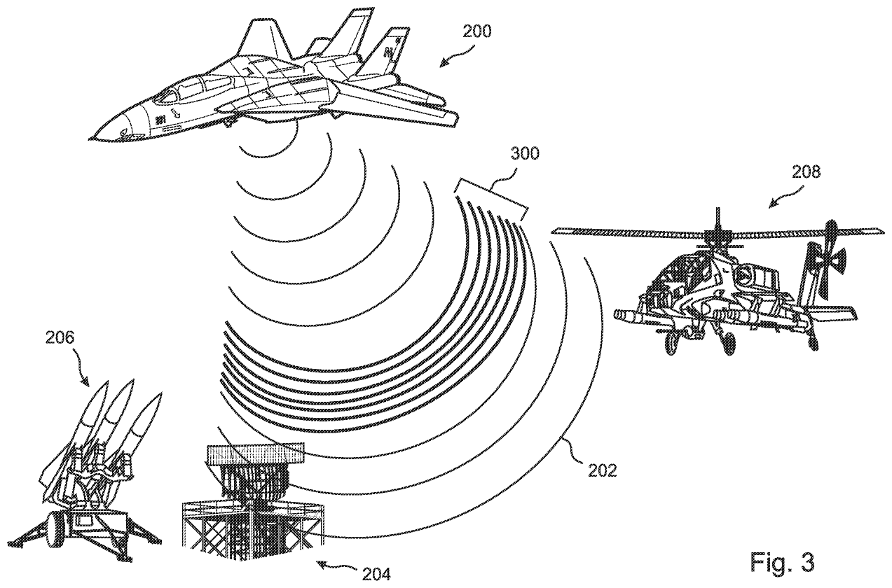

In the example of FIG. 3, the communication signals 300 are interleaved in time with EW signals 202, which can, for example, be radar jamming signals 202, such that both are transmitted alternately at the same frequency. In the illustrated example, a first aircraft 200 transmits bursts of communication signals 300 that are interspersed between transmissions of an EW waveform 202. The transmitted communication bursts 300 are received by the EW/COMM of a second aircraft 208, which is also monitoring the RF environment to detect any hostile communication signals and/or hostile EW waveforms. It will be noted that the denser spacing in FIG. 3 between the illustrated RF waves of the communication signals 300 as compared to the EW waveform 202 is intended only to differentiate the burst of communication 300 from the EW waveform 202, and does not imply that the communication signals 300 are at a different RF frequency from the EW waveform 202.

With appropriate encryption of the communications 300, this approach of interleaving communication signals 300 with EW waveforms 202 at the same RF frequency renders the communication signals 300 almost indistinguishable from the EW waveforms 202, thereby obfuscating the communication signals 300 such that hostile detection and interception of the communication signals 300 is rendered highly difficult.

In embodiments, the communication signals are complex (real and imaginary) “IQ” signals, i.e. digital signals that are encoded in both amplitude and phase. In some embodiments, the communication signals are transmitted using the “digital data link” (DDL) protocol.

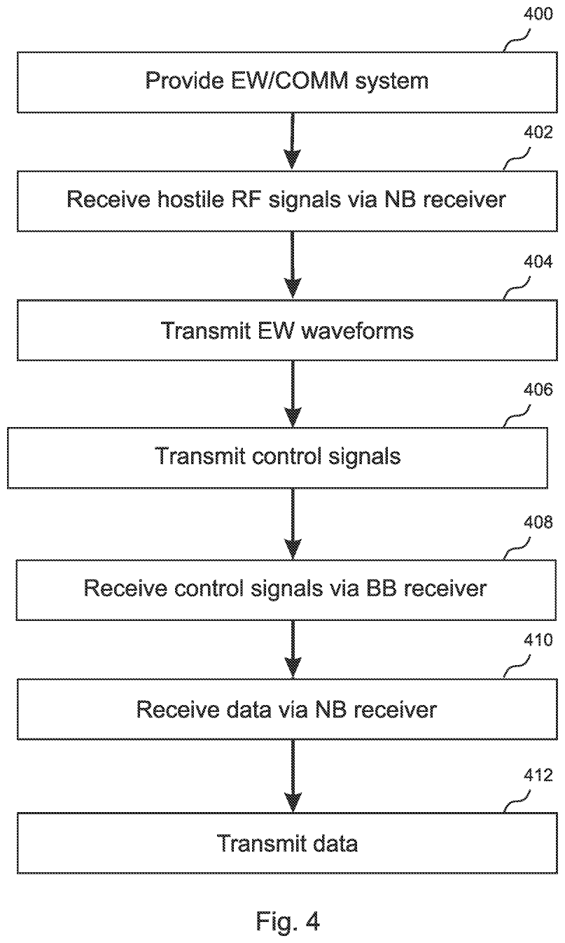

With reference to FIG. 4, in an embodiment the method of the present disclosure includes providing an EW/COMM system as described above 400. Electronic warfare is carried out by the EW/COMM by receiving hostile RF signals using the NB receiver 402 and transmitting EW waveforms 404 in response. When communication via the EW/COMM is desired, control signals are transmitted 406 at a low power level, and received using the BB receiver 408. According to a frequency and timing pattern negotiated via the control signals, bursts of data can then be received 410 and transmitted 412, where the data is received by the NB receiver 410.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

Although the present application is shown in a limited number of forms, the scope of the invention is not limited to just these forms, but is amenable to various changes and modifications. The disclosure presented herein does not explicitly disclose all possible combinations of features that fall within the scope of the invention. The features disclosed herein for the various embodiments can generally be interchanged and combined into any combinations that are not self-contradictory without departing from the scope of the invention. In particular, the limitations presented in dependent claims below can be combined with their corresponding independent claims in any number and in any order without departing from the scope of this disclosure, unless the dependent claims are logically incompatible with each other.

I claim:

1. A hybrid system that is a hybrid RADAR and signal communication system, the hybrid system comprising:
an antenna;
an RF receiving system comprising a broadband receiver and a narrowband receiver, the broadband and narrowband receivers being configured to enable the broadband receiver to continuously monitor a broad frequency range while concurrently the narrowband receiver detects signals that are received within a narrow frequency band included within the broad frequency range;
an RF transmitting system;
a RADAR control module configured to control the generation and receiving of RADAR energy by the antenna, RF receiving system, and RF transmitting system; and
a communications module (COMMS) configured to control transmitting and receiving of communication signals by the antenna, RF transmitting system, and RF receiving system.

2. The hybrid system of claim 1, wherein the COMMS is not physically distinct from the RADAR control module, but instead is a module of software code that is included in non-transient media within the RADAR control module.

3. The hybrid system of claim 1, wherein:
the RADAR system is an electronic warfare (EW) system;
the RADAR module is an EW control module;
the hybrid system is an EW/COMM system;
the broadband frequency range is an EW frequency range;
the receiving system is configured to receive a hostile waveform at any frequency within the EW frequency range;
the EW control module is configured to generate an EW waveform in response to the received hostile waveform;
the RF transmitting system is configured to transmit the EW waveform at any frequency within the EW frequency range;
the communication signals can be transmitted and received at any selected frequency within the EW frequency range; and
the broadband and narrowband receivers are configured to enable the broadband receiver to continuously monitor the full EW frequency range while, concurrently, the narrowband receiver detects hostile electronic warfare signals that are received within the narrow frequency band.

4. The hybrid system of claim 3, wherein the EW frequency range extends at least from 400 MHz to 36 GHz.

5. The hybrid system of claim 1, wherein the broadband receiver is further configured to receive control signals transmitted over a predetermined pattern of frequencies within the EW frequency range.

6. The hybrid system of claim 1, wherein the narrowband receiver is further configured to receive data communications.

7. The hybrid system of claim 1, further comprising a scrambler and a descrambler configured for encrypting and decrypting the communication signals.

8. The hybrid system of claim 1, wherein the hybrid system comprises a plurality of antennae.

9. The hybrid system of claim 8, wherein at least one of the antennae is dedicated to only transmitting and/or receiving communication signals.

10. The hybrid system of claim 8, wherein at least one of the antennae is dedicated to only transmitting and/or receiving radar signals.

11. The hybrid system of claim 1, wherein the COMMS is configured to generate and to receive communication signals according to the digital data link (DDL) protocol.

12. The hybrid system of claim 1, wherein the COMMS is configured to generate and to receive IQ encoded communication signals.

13. Non-transient media containing software, the non-transient media being included in a hybrid electronic warfare and signal communication system (EW/COMM) comprising:
an antenna;
a receiving RF amplifier that is configured to receive a hostile waveform at any frequency within the EW frequency range;
an RF receiving system;
an EW control module configured to generate an EW waveform in response to the received hostile waveform;
a transmitting RF amplifier that is configured to transmit the EW waveform at any frequency within an EW frequency range of the EW/COMM; and
a communications module (COMMS) configured to generate and receive communication signals, the communication signals being transmittable and receivable via the antenna, the receiving system, and the transmitting and receiving RF amplifiers, at any selected frequency within an EW frequency range of the EW/COMM;
the software, when executed by the EW/COMM system, being configured to cause the EW/COMM system to communicate data while also concurrently engaging in electronic warfare by executing the steps of:
causing the EW control module to receive a hostile RF signal at an EW frequency via the antenna, the receiving RF amplifier, and the RF receiving system;
causing the EW control module to transmit an EW waveform at the EW frequency via the transmitting RF amplifier and antenna;
causing the COMMS to obtain received data at a communication receiving frequency via the receiving RF amplifier and RF receiving system; and
causing the COMMS to emit transmitted data at a communication transmitting frequency via the transmitting RF amplifier.

14. The non-transient media of claim 13, wherein the communication transmitting and receiving frequencies are both substantially equal to the EW frequency.

15. The non-transient media of claim 14, wherein the receiving and transmitting by the COMMS occurs during gap times when the EW control module is neither receiving the hostile RF signals nor transmitting the EW waveforms.

16. The non-transient media of claim 13, wherein the EW/COMM further comprises a broadband receiver and a narrowband receiver, the narrowband receiver being physically distinct from the broadband receiver, and wherein the software is further configured to cause the EW/COMM system to execute the steps of:
causing the broadband receiver to continuously monitor the EW frequency range for hostile RF energy;
causing the COMMS to transmit first control signals over a first control channel implemented according to a predetermined first frequency pattern;
causing the COMMS to receive second control signals via the broadband receiver over a second control channel implemented according to a predetermined second frequency pattern;
causing the COMMS to transmit the transmitted data at a first data communication frequency; and
causing the COMMS to receive the received data at a second data communication frequency via the narrowband receiver;
the first and second communication frequencies being determined according to the first and second control signals.

17. The non-transient media of claim 16, wherein the EW frequency and the second data communication frequency are both within a bandwidth of the narrowband receiver.

18. The non-transient media of claim 17, wherein the hostile RF signals and the received data are concurrently received by the narrowband receiver.

19. The non-transient media of claim 17, wherein the EW frequency is substantially equal to the second data communication frequency, and wherein the received data is received during gap times when the narrowband receiver is not receiving the hostile RF signals.
